(19) United States
(12) Patent Application Publication
(10) Pub. No.: US 2010/0300847 A1
(43) Pub. Date: Dec. 2, 2010

(54) DEVICE AND METHOD FOR CONVEYING AND SIMULTANEOUSLY STABILISING FLEXIBLE, TWO-DIMENSIONAL OBJECTS

(75) Inventor: Simon Guhl, Wetzikon (CH)

Correspondence Address: RANKIN, HILL & CLARK LLP, 38210 GLENN AVENUE, WILLOUGHBY, OH, 44094-7808, US

(73) Assignee: FERAG AG, Hinwil (CH)

(21) Appl. No.: 12/789,680

(22) Filed: May 28, 2010

(30) Foreign Application Priority Data
Jun. 2, 2009 (CH) 00835/09

(51) Int. Cl. B65G 17/46; B65G 17/32

(52) U.S. Cl. 198/803.3; 198/793

(57) ABSTRACT

The invention relates to a device (1) and a method for conveying flexible, two-dimensional objects (100, 100), in particular printed products, with a plurality of conveyor elements (10) which are movable in a conveyor direction (F) by a conveyor member (20) drivable along a closed revolving path (U) and which are capable of receiving and conveying at least one object (100, 100′). A stabilisation device (30) with at least one stabilisation member (32, 33, 36) is present for stabilising the objects (100, 100′), in particular in regions (B) of the revolving path (U), in which large accelerations occur. The stabilisation device (30) forms a compliant stabilisation line (34′) or stabilisation surface (34) and presses the objects (100, 100′) against the conveyor element (10) at least in a part of the revolving path. By way of this, one prevents the objects from being displaced relative to the conveyor element (10), which may lead to problems with the further processing.

### BACKGROUND OF THE INVENTION

### Field of the Invention

The invention lies in the field of conveyor technology and relates to a device as well as to a method for conveying and simultaneous stabilisation of flexible, two-dimensional objects, in particular printed products.

Conveyor systems with conveyor elements, e.g. grippers or pockets, which are moved along a closed revolving path, necessarily have regions in which the orientation of the revolving path and thus the momentary conveyor direction changes. If flexible objects are received and conveyed by the conveyor elements, then in curved sections of the revolving path, it may occur that held products are upset to the front or rear due to gravity and/or accelerations in the conveyor direction. This is disadvantageous above all in those cases, in which the objects are to be fed by the conveyor elements to a further processing step, which requires a defined object position in or relative to the conveyor element.

The outlined problem may occur, for example, in a device as is described in the CH patent application No. 1724/08 which has no prior application. This device serves for collecting printed products in grippers along a part of the revolving path, which acts as a collection path. The grippers have an extended gripper jaw which in particular when collecting (in the opened condition of the gripper) acts as a support surface. If the collection procedure has been carried out in a correct manner, the objects are released to a further-processing station, e.g. inserted into folded printed products. This release, as a rule, is effected at a location which lies above the collection path. If an error has been ascertained, in particular the absence of a product, the objects are not released, but are conveyed back to the collection path in a repair run-through, where the missing product may be added. In the dropping part of the revolving path, it may occur that the objects are upset to the front due to gravity and, thus, no longer lie on the support surfaces orientated opposite to the conveyor direction. This however leads to the fact that the repair procedure may no longer be carried out, in particular since missing products may not be correctly applied, if the objects lying therebelow are folded over to the front.

An undesired positional change of the received objects may also occur with other applications. Sharp curves, however, may often not be avoided for reasons of space (limited space).

### BRIEF SUMMARY OF THE INVENTION

It is, therefore, the object of the invention to avoid the disadvantages of the state of the art and to provide a conveyor device and a corresponding conveyor method, with which an undesired positional change of the conveyed objects may be avoided, even with larger accelerations.

The conveyor device according to the invention serves for conveying flexible, two-dimensional, i.e. flat, objects, in particular printed products. It comprises a plurality of conveyor elements which are movable in a conveyor direction by way of a conveyor member drivable along a closed revolving path, and which are capable of receiving and conveying at least one object. It is particularly the case of grippers which receive the objects and fix them in a clamping manner. The conveyor elements may, however, also be pockets or other receiver compartments, in which objects are held in a non-clamped manner. The conveyor member, for example, is a chain, which is guided in a channel, by way of whose shape the revolving path is also set. According to the invention, at least one stabilisation device with at least one stabilisation member is present, which is capable of acting on the object at least in a part of the revolving path. The stabilisation member forms a compliant, flexible stabilisation surface or stabilisation line for the objects, which preferably runs essentially parallel to the revolving path. Said stabilisation surface or stabilisation line is preferably resilient. It is, thus, not the case of a rigid guide surface, but the stabilisation force on account of its compliance may adapt flexibly to different objects, without the objects jamming or having too much play. The stabilisation member presses the objects against the conveyor element and, thus, realises a defined position relative to the conveyor element.

Brush strips or co-moved or stationary strips or belts or other elastic elements serve as a stabilisation member. The latter is given the desired shape by way of suitable guide elements or deflection elements as well as, as the case may be, by way of the cooperation with the conveyor elements. The mentioned stabilisation members are mechanically simple. A stabilisation may therefore be realised with little effort and inexpensively, and leads to a significantly reduced rejection.

The stabilisation member preferably acts on the objects in a part of the revolving path, by way of the path direction changing and therefore by way of forces acting on the objects, which without stabilisation would lead to a position change relative to the conveyor element. Such parts, for example, are regions in which the path directions or path speed changes, the revolving path rises, falls and/or in which the conveyor elements change their orientation with respect to the revolving path, for example because the conveyor member or its guide is twisted (twisted here includes a winding about an axis). The invention also permits the use of an overhanging revolving path, i.e. upside down conveying, without the objects changing their general position to the conveyor element. In particular, the leading edge of the objects is always leading and the trailing edge always trailing.

In a preferred variant, the conveyor elements comprise a support surface, which is inclined in or opposite to the conveyor direction, so that received objects bear on the support surface due to gravity, with a horizontal conveyor direction. The conveyor elements may thus particularly be applied for collection. The stabilisation members are preferably designed such that they press the objects against the support surface or towards the revolving path of the conveyor elements. The support surface is, therefore, flexible in this direction and preferably co-biased, so that it may exert pressure in the direction of the revolving path of the conveyor elements. This applies at least in the regions, in which forces act on the objects, which without stabilisation would lead to a lifting of the objects from the support surface. Alternatively, the stabilisation members may also be designed such that the stabilisation surface or stabilisation line has a distance to the support surface, so that no pressure is exerted onto the support surface, but an upset of the objects to the front or to the rear is prevented.

Preferably, the support surface has at least one groove, into which the at least one stabilisation member is capable of engaging. The stabilisation member and support surface thus cooperate in a meshing manner. One may also reliably stabilise objects, which are shorter than the support surface, thus which do not project beyond the edge which is distant to the conveyor member, at this end, on account of this measure.

The invention may advantageously be applied with the initially mentioned device according to CH patent application No. 1724/08. With this device, for the collection, one does not use pockets, but grippers with an extended or widened gripper jaw, which simultaneously serves as a support surface and collection rest. The extended gripper jaw is preferably designed in a two-part manner, wherein the two gripper jaw parts are pivotable relative to one another, in particular are controlled.

Instead of a position, in which the held edge is leading, the held edges may also be trailing and the objects stabilised in this position. Moreover, an application with conveyor devices other than gripper conveyors, with which a position change of the objects is to be counteracted, is likewise conceivable. A gripping of the objects by the conveyor units is not absolutely necessary, and the objects for example may also be stabilised in pockets without any clamping function, by which means a clamping function may be done away with.

Rigid guide elements, e.g. guide rails may be present additionally to the stabilisation device. These for example are arranged in front of the stabilisation device in the conveyor direction, and effect a pre-positioning of the objects.

### BRIEF DESCRIPTION OF THE DRAWINGS

Examples of the invention are shown in the drawing and are described hereinafter. In a purely schematic manner, there are shown in:

FIG. 1 a conveyor device with a stabilisation device, which comprises at least one brush strip;

FIGS. 2a-c a conveyor device with a stabilisation device, which comprises at least one driven round belt;

FIG. 3 a conveyor device with a stabilisation device, which comprises at least one elastic element;

FIG. 4 a conveyor device with a stabilisation in an overhanging section of the movement path;

FIG. 5 a conveyor device with a stabilisation in a twisted section of the movement path.

### DETAILED DESCRIPTION OF THE INVENTION

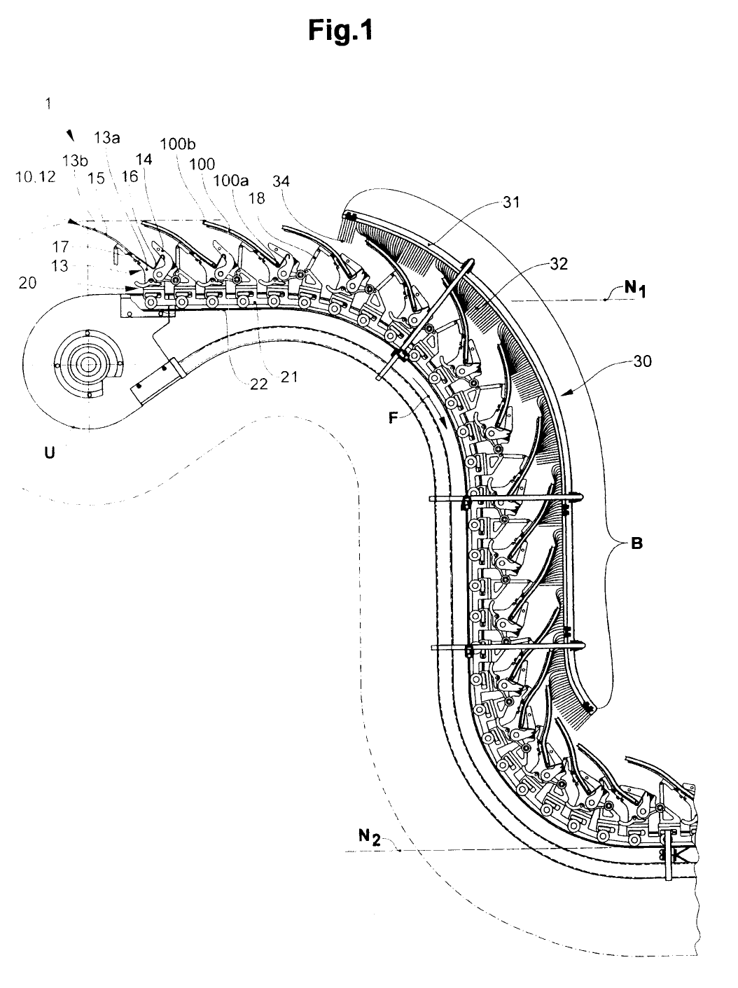

FIG. 1 shows a conveyor device 1 with a plurality of conveyor elements 10 and a first variant of a stabilisation device 30. The conveyor means 1 here is shown merely by way of example. Basically, one may also use differently shaped conveyor elements 10.

The conveyor device 1 comprises a plurality of conveyor elements 10, which here are designed as grippers 12 with a first gripper jaw 13 and with a second gripper jaw 14. The first and second gripper jaw 13, 14 are pivotable about a pivot axis S between an open position and a clamping position. The grippers 12 are fastened on a conveyor member 20 in the form of a chain with several chain links 21. The chain 20 is moved in a guide member 22, here a channel. The revolving path U of the chain 20 and by way of this, also the path of the grippers 12, is defined by way of the shape of the channel 22. The trailing first gripper jaw 13 of the gripper 12 here consist of two gripper jaw parts 13a, 13b which are pivotably connected to one another via a joint 17. The pivot position is controlled via a control element 18. The control element 18 here is present in the form of a lever, which is pivotably connected to the trailing chain link 21. The pivot position changes depending on the shape of the revolving path.

The two gripper jaw parts 13a, 13b define a support surface 15 for the received objects 100. The objects in a region of the revolving path, in which the grippers 12 are open and in which the support surface 15 points upwards or obliquely to the front or rear, may be introduced into the gripper 12 or applied onto the support surface 15. Thereby, they are aligned on an abutment 16, which is formed by the base of the gripper jaw. Objects 100 may be fed at several stations and, thus, may be collected in the open gripper 12. The gripper 12 is subsequently closed. The objects 100 are fixed at their leading edge 100a and may, thus, be conveyed in a clamped manner along an infinitely shaped path U. This is described in the already motioned application CH 1724/2008. The two-part support surface 15 permits a good leading of the objects 100 with their release. This is described in the application CH 00553/2009 which has no prior publication.

The stabilisation device 30 according to the invention, acts on the objects 100 or the conveyor elements 10 in a region B of the revolving path U, in which this revolving path U drops from a first level N1 to a second level N2. The conveyor elements 100 here have a movement component in the downwards direction (thus towards the ground). Without a stabilisation device 30, the objects 100 which are only fixed at their leading edge 100a, under certain circumstances would release from the support surface 15, so that their trailing edges 100b are upset to the front or to the rear. With the transition into a section of the revolving path with a reduced curvature or horizontal alignment, this folded-over position under certain circumstances is retained. The stabilisation device 30 counteracts this folding-over by way of it pressing the objects 100 gently and with a low force against the support surface 15 in the sloping region B. For this, according to the invention, it forms a compliant stabilisation surface or stabilisation line.

Here, the stabilisation device 30 comprises at least one stabilisation member in the form of a brush strip 32. The brush strip 32 is fastened on a holder 31, which has somewhat the shape of the revolving path U in the region B, thus runs roughly parallel to the revolving path U. The bristles of the brush strip 32 are aligned roughly perpendicularly to the holder 31 or to the revolving path U. In the unloaded condition (i.e. without the presence of conveyor elements 10) they therefore define a bent stabilisation surface 34, running parallel to the revolving path U and having a distance from this, which is smaller than the minimal distance of the non-held object edge 100b to the revolving path U. On moving the conveyor elements 10 through the region B, the bristles are deformed and brush along the support surface 15. By way of this, the objects 100 are pressed softly against the support surface 15 and thus are well positioned. The stabilisation surface 34 which is formed by the envelope of the brush strip 32, is elastically deformed by way of this and obtains a type of wave shape or saw-tooth shape. The pressure on the objects 100 is so small, that these are not compromised, and also no jamming occurs.

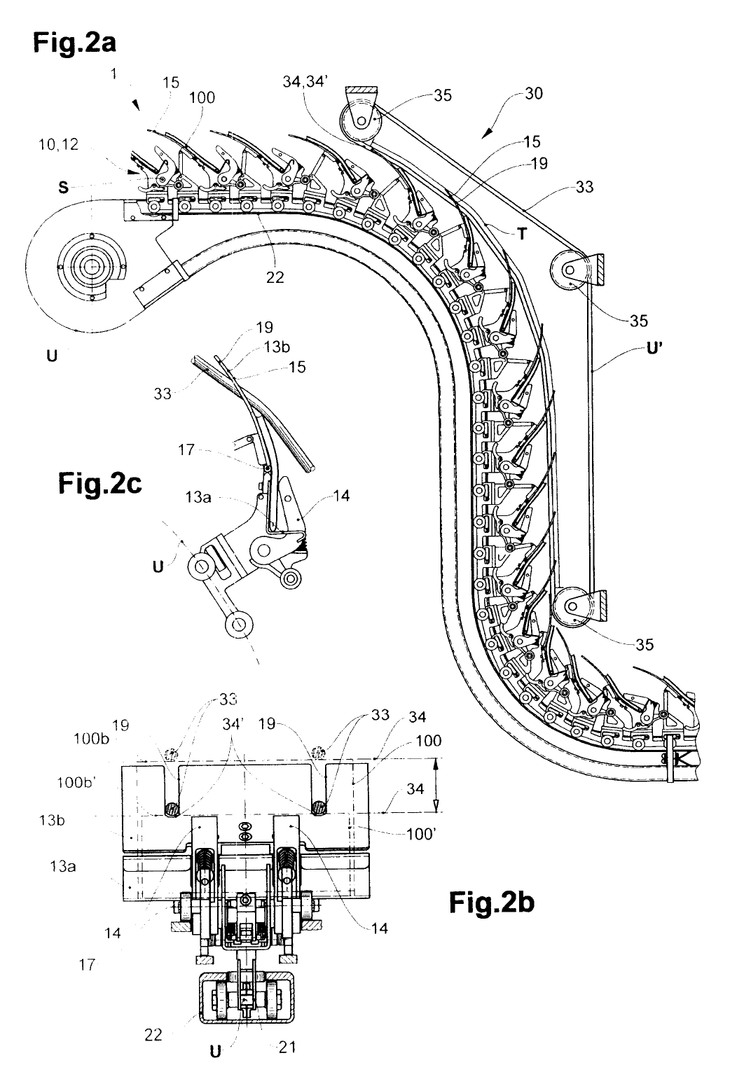

Preferably, the support surface 15 in the second gripper jaw part 13b has at least one groove 19, into which the stabilisation member may engage. This is shown in FIG. 2b with regard to one variant of the stabilisation device 30. The groove 19 permits one to also stabilise objects 100 which are shorter than the support surface 15.

Preferably two parallel brush strips 32 are present, which engage into two grooves 19. Instead of brushes of natural material or plastic, one may also use surfaced, i.e. flat, flexible rubber elements.

FIGS. 2a-c show a conveyor device 1 as in FIG. 1, with a further embodiment of the stabilisation device 30. This here comprises at least one stabilisation member in the form of a round belt 33. Preferably, two parallel round belts 33 are present. The round belts 33 are guided via deflection rollers 35, such that they may act on the conveyor elements 10 or the objects 100 held therein, in a part region T of their path U′ (T thus corresponds to the active section of the belt 33). This region T in the present example would be almost straight in the unloaded condition (without the presence of conveyor elements 10). With more or differently arranged deflection rollers 35, one may realise other path curves U′. The round belt 33, by way of the conveyor elements 10 which push the round belt 33 away from the revolving path U, is deformed such that the region T is roughly parallel to the revolving path U. The round belt 33 therefore in the region T defines a compliant stabilisation line 34′. A stabilisation surface 34 is set (see FIG. 2b) if two parallel round belts 33 are present. The round belt 33 exerts a slight pressure directed towards the channel 22, but is compliant (direction of the double arrow in FIG. 2b), and may thus adapt to different object formats.

The round belt 33 is preferably driven by way of a drive which is not represented in more detail here, with the same or with a reduced speed with regard to the conveyor elements 10.

FIGS. 2b+c show the stabilisation of the objects 100 with a different format. The object 100 has a length which is so large that its non-held edge 100b projects beyond the support surface 15. The object 100′ has a smaller length, so that its non-held edge 100b′ does not project beyond the support surface 15. The support surface 15 has two parallel grooves 19. The round belts 33 are guided such that they may run in the grooves 19 and are compliant in the direction of the grooves 19. This is indicated in FIG. 2 by a double arrow. With a smaller format, the round belts 33 run in the grooves 19 and act on the free edge 100b′ (see also lateral view FIG. 2c). With a larger format, the distance of the round belt 33 to the revolving path U is increased, and the round belts 33 run outside the conveyor surface 15. In any case, the free edges 100b, 100b′ are reliably supported. The same effect occurs, when with regard to the stabilisation members, it is the case of other means, which may engage into the grooves, e.g. the brushes or brush strips shown in FIG. 1.

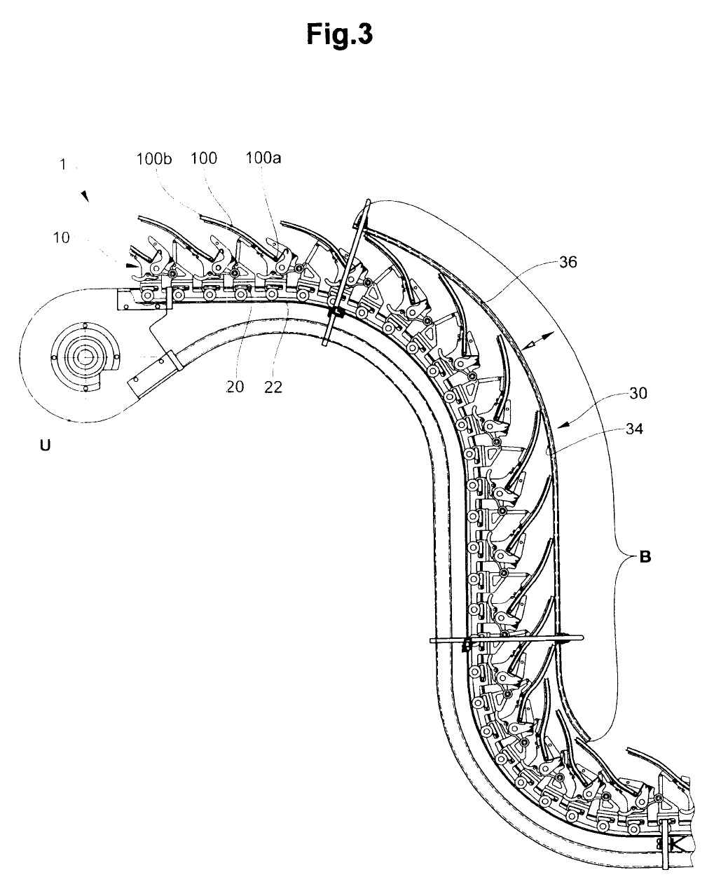

FIG. 3 shows an example with a stabilisation device 30, which as a stabilisation member comprises a stationary, elastically deformable element 36. The element 36, for example, is a leaf spring whose shape is adapted to the shape of the revolving path in the region B and which is arranged parallel to this. It may be mounted on one side. It may also be the case of a compliant steel wire, a rubber band or a spiral spring with a very narrow winding distance. In this case, the element 36 is preferably mounted on two sides, such that it spans the region B. Preferably, as with the above mentioned examples, two elements are present 36 which may engage into corresponding grooves 19 in the conveyor elements 10.

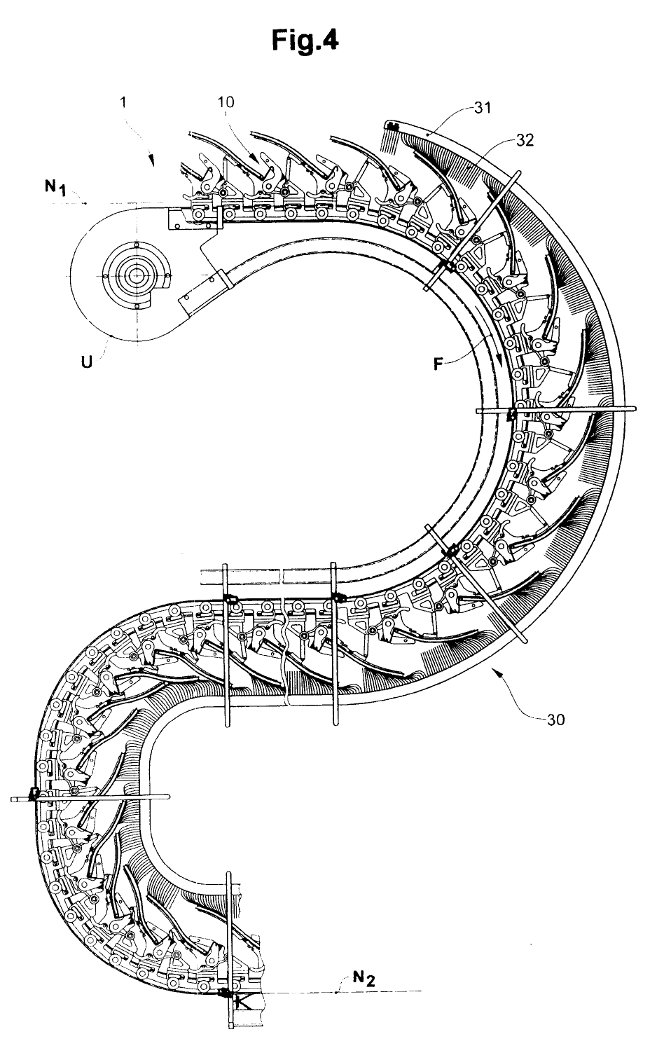

FIG. 4 shows an example, as to how the stabilisation device 30 may be applied with a conveyor path, with which the objects, for example, are conveyed upside down in regions. The revolving path U has a region bent in an S-shaped manner. The stabilisation device 30, which here may be realised by way of each of the variants shown in FIG. 1-3 (the brush strips according to FIG. 1 are shown only by way of example), extends over the complete part region B by way of the inclination of the revolving path exceeding a predefined value and by way of conveying upside down.

The conveying upside down, without the objects changing their position relative to the conveyor element 10 is only possible at all due to the stabilisation device. By way of this, it is possible to realise the conveyor path in a relatively restricted space, for example the overcoming of the height difference from the level N1 to level N2, without enlarging the installation in the horizontal direction.

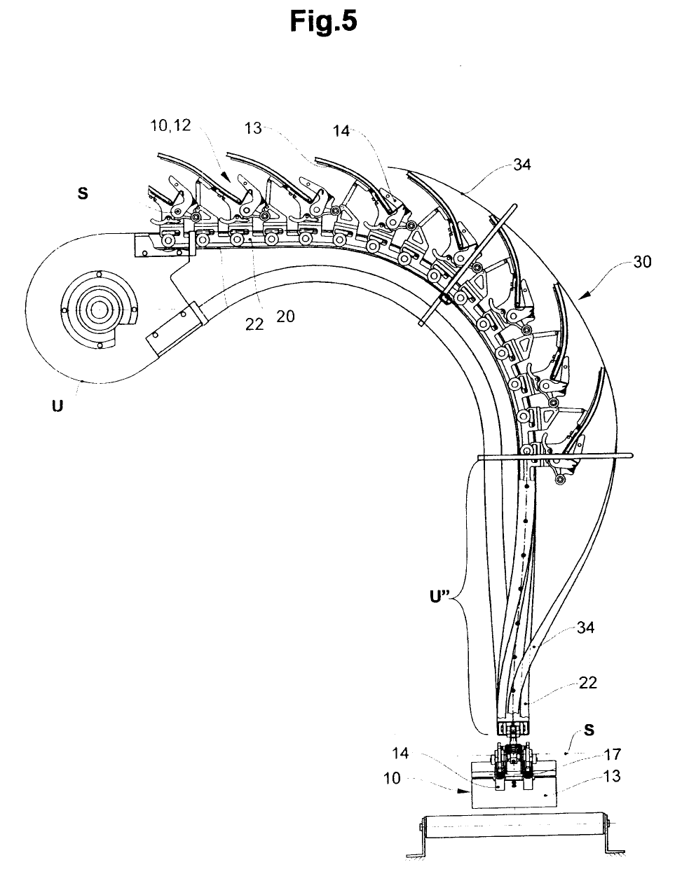

FIG. 5 shows a further example, with which the revolving path U has a section U″ which is twisted (twisted here includes a winding about an axis). The conveyor elements 10 here undergo a rotation about 90° from a position, in which the pivot axis S of the gripper 12 lies perpendicular to the drawing plan, into a position, in which the pivot axis S lies in the plane of the drawing. Additionally, the revolving path U drops greatly in this section U″. The stabilisation device 30 is arranged such that its stabilisation surface 34 follows the course and the orientation of the revolving path U. The stabilisation surface is therefore firstly arranged perpendicular to the plane of the drawing, and in the section U″ is rotated into a position parallel to the plane of the drawing.

Such twisted sections are only possible at all due to the stabilisation, since the accelerations which occur thereby are compensated by the stabilisation device 30, such that the object 100 does not detach from the support surface 15. It is possible by way of such twisted sections to design the revolving path and adjacent processing stations with greater flexibility with regard to space.

1. A device (1) for conveying flexible, two-dimensional objects (100, 100′), in particular printed products, with a plurality of conveyor elements (10) which are movable in a conveyor direction (F) by way of a conveyor member (20) drivable along a closed revolving path (U), and which are capable of receiving and conveying at least one object (100, 100′), characterised by at least one stabilisation device (30) with at least one stabilisation member (32, 33, 36), wherein the stabilisation device (30) forms a compliant stabilisation line (34′) or stabilisation surface (34) and is capable of pressing the objects (100, 100′) against the conveyor element (10), at least in a part of the revolving path.

2. A device according to claim 1, characterised in that the stabilisation member (32, 33, 36) in a part (B) of the revolving path (U) is capable of acting on the objects (100, 100′) by way of forces acting on the objects (100 100′), which without a stabilisation, would lead to a position change relative to the conveyor element.

3. A device according to claim 1 or 2, characterised in that the stabilisation member (32, 33, 36) in a part (B) of the revolving path (U), is capable of acting on the objects (100, 100′) by way of the revolving path (U) rising, dropping and/or twisting.

4. A device according to one of the preceding claims, characterised in that the stabilisation member (32, 33, 36) is a brush strip, a stationary or revolving belt or a stationary or revolving round belt or comprises an elastically deformable element.

5. A device according to one of the preceding claims, characterised in that the conveyor elements (10) are grippers (12) with two gripper limbs (13, 14) which are pivotable relative to one another, between which at least one object (100, 100′) may be received in a clamping manner.

6. A device according to one of the preceding claims, characterised in that the conveyor elements (10) comprise a support surface (15), wherein the support surface (15) is inclined in or opposite to the conveyor direction (F), so that received objects (100, 100) bear on the support surface (15) with a roughly horizontal conveyor direction (F).

7. A device according to claim 6, characterised in that the support surface (15) comprises at least one groove (19), into which the at least one stabilisation member (32, 33, 36) is capable of engaging.

8. A device according to claim 7, characterised in that the stabilisation member (32, 33, 36) is resilient in the direction of the groove (19).

9. A device according to claim 7 or 8, characterised in that the support surface (15) comprises at least two grooves (19) arranged next to one another, and the stabilisation device (30) comprises at least two parallel stabilisation members (32, 33, 36).

10. A device according to one of the claims 6 to 9, characterised in that the grippers (12) comprise a first gripper limb (13) and a second gripper limb (14), which are pivotable relative to one another for receiving at least one object (100, 100′) in a clamping manner, and that the first gripper limb (13) is extended with respect to the second gripper limb (14) and forms the support surface (15).

11. A device according to claim 10, characterised in that the first gripper limb (13) is formed of two parts, with a first gripper limb part (13a) and a second gripper limb part (13b), wherein the orientation of the two gripper limb parts (13a, 13b) relative to one another is variable and is preferably controllable.

12. A stabilisation device (30) with at least one stabilisation member (32, 33, 36) for use with a device (1) according to one of the preceding claims.

13. A method for conveying flexible, two-dimensional objects (100, 100′), in particular printed products, with the following steps
receiving at least one object (100, 100′) by a conveyor element (10);
conveying the at least one object (100, 100′) by way of moving the conveyor elements (10) by way of a conveyor member (20), along a closed revolving path (U) in a conveyor direction (F);
stabilising the at least one object (100, 100′) by way of a stabilisation device (30) with at least one stabilisation member, by way of acting on the objects (100, 100′) at least in a part of the revolving path, wherein the stabilisation member (32, 33, 36) defines a compliant stabilisation surface (34) or stabilisation line (34′) for the objects (100, 100′) and presses the objects (100, 100′) against the conveyor element (100) at least in a part of the revolving path.

14. A method according to claim 13, characterised in that the objects (100, 100′) are stabilised in a part (B) of the movement path (U), in which the orientation of the movement path (U) and/or of the conveyor elements (10) and/or the speed of the conveyor elements (10) changes.
